(19) United States
(12) Patent Application Publication
(10) Pub. No.: US 2025/0257610 A1
(43) Pub. Date: Aug. 14, 2025

(54) LADDER SYSTEMS HAVING A BASE AND INTERCHANGEABLE ATTACHMENTS

(71) Applicant: BLUE MOON DESIGNS, LLC, Bend, OR (US)

(72) Inventor: Dale Martin NEUBAUER, Bend, OR (US)

(21) Appl. No.: 18/436,524

(22) Filed: Feb. 8, 2024

(51) Int. Cl. E06C 1/28; E06C 1/397; E06C 7/42

(52) U.S. Cl. CPC E06C 1/28; E06C 1/397; E06C 7/42

(57) ABSTRACT

A ladder system is disclosed that includes a base unit comprising a base assembly and a pair of support legs extending horizontally from the base assembly, and at least one ladder module configured to be releasably mounted on the base unit to extend vertically therefrom. The base unit and ladder module together form a stable free-standing ladder in which the ladder module is cantilevered out from the base unit.

### BACKGROUND

In industrial applications, for example in the repair of aircraft, a variety of different ladders are often necessary. For example, ladders of different lengths may be needed, as well as ladders having different functionality. It is very important for safety that these ladders be stable, and that they be capable of being safely supported in a way that provides the access needed by the user. For example, a conventional folding ladder cannot be positioned relative to the curved body of a helicopter in a manner so that the mechanic is positioned in close proximity to the aircraft. Whether placed parallel to or at an angle to the body of a helicopter, the poor fit of the ladder to the aircraft compromises the ability of the mechanic to perform his work and creates a hazardous condition when he is forced into awkward or unstable positions.

In the field of aircraft maintenance, U.S. Pat. No. 10,246,939, the complete disclosure of which is incorporated herein by reference, describes ladder systems that include extension modules that can be securely attached to the top of a folding or fixed ladder, allowing length to be added to the ladder. The extension modules are not free standing and cannot be used separately from the ladder.

### SUMMARY

The present disclosure features ladder systems that provide moveable safety ladders and work platforms that can be easily reconfigured by a user. The ladder systems include a compact base unit and a plurality of ladder modules configured to be securely and removably attached to the base unit.

In some implementations the ladders and platforms are configured to be placed in close proximity to helicopters, aircraft and other vehicles or equipment in order to provide human workers with a safe and stable means of accessing, inspecting, or servicing those and similar machines.

In one aspect, the disclosure features a ladder system that includes (a) a base unit comprising a base assembly and a pair of support legs extending horizontally from the base assembly; and (b) at least one ladder module configured to be releasably mounted on the base unit to extend vertically therefrom. The base unit and ladder module together form a stable free-standing ladder in which the ladder module is cantilevered out from the base assembly.

Some implementations may include one or more of the following features. The support legs may extend to distal ends configured for engagement with a surface on which the base unit is positioned. The support legs may have an arched profile. Alternatively, the support legs may be straight.

In some implementations the ladder module is mounted on the base assembly. The base assembly may include a box structure having side walls connected by lateral supports. The base assembly may be configured such that the side walls are load bearing for the ladder module. The base assembly may be configured to be positioned under a lowermost step of the ladder module.

The ladder system may further include a base unit connector element mounted on each side wall and a corresponding ladder module connector element mounted on a side rail of the ladder module for engagement with the base unit connector element. The base unit connector element may be in the form of a generally V-shaped slot and the ladder module connector element may be a tang element shaped to fit within the slot in a wedged engagement.

The ladder system may include a set of ladder modules having different configurations for interchangeable use with the base unit. One or more of the ladder modules may be a walk-through ladder module.

In another aspect, the disclosure features a base unit for use in a ladder system that includes a plurality of ladder modules, the base unit comprising: a base unit comprising (a) a base assembly having a pair of connector elements configured to engage a corresponding pair of connector elements on a ladder module in a releasable locking and load bearing engagement, and (b) a pair of support legs extending horizontally from the base assembly, at least a portion of each support leg being in contact with a surface on which the base unit is positioned during use.

Some implementations of the base unit may include one or more of the following features. The base unit may be configured to support the ladder module so as to form a stable free-standing ladder in which the ladder module is cantilevered out from the base assembly. The base assembly may be configured to be positioned under a lowermost step of the ladder module. The support legs may have an arched profile. The base assembly may include a box structure having side walls connected by lateral supports. The base unit may be configured such that the side walls are load bearing for the ladder module.

In another aspect, the disclosure features a method of using the base unit with interchangeable ladder modules. For example, the disclosure features a method comprising: (1) providing (a) a plurality of ladder modules, each of the ladder modules including a pair of connecting elements, and (b) a base unit comprising (i) a base assembly; (ii) a pair of connector elements configured to engage the connector elements on the ladder modules in a releasable locking and load bearing engagement, and (iii) a pair of support legs extending horizontally from the base assembly, (2) positioning the base unit on a surface such that at least a portion of each support leg is in contact with the surface; and (3) attaching a first one of the ladder modules to the base unit by engaging the connector elements on the first ladder module with those on the base unit to form a free-standing ladder.

In some implementations the connector elements of the base unit are positioned on the base assembly.

In some implementations the method also includes detaching the first ladder module from the base unit by disengaging the connector elements of the first ladder module from those of the base unit. The method can then include attaching a second one of the ladder modules to the base assembly by engaging the connector elements on the first ladder module with those on the base unit.

In some cases, the base assembly includes wheels, and the method further comprises using the wheels to move the base unit, with or without the first ladder module attached, from a first location to a second location.

The method may include positioning the free-standing ladder adjacent to a piece of equipment having a curved surface, for example an aircraft or a tank, such that a distal end of the first ladder module is cantilevered out from the base unit and is positioned to allow a user to service the equipment from the ladder.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a ladder system according to one implementation, showing a ladder formed by the interconnection of a ladder module with a base unit.

FIG. 1A shows the ladder system of FIG. 1 with the ladder module shown exploded from the base unit.

FIG. 2 is a perspective view of the base unit shown in FIGS. 1 and 1A.

FIG. 2A is a partially exploded view of the base unit of FIG. 2.

FIG. 2B is a top view of the base unit.

FIG. 2C is a side view of the base unit.

FIG. 2D is a front view of the base unit.

FIG. 3 is an exploded view of the base unit in which the base assembly is also exploded.

FIG. 4 is a side view of an assembled ladder system.

FIG. 4A is a side view similar to FIG. 4 but showing the ladder system tipped up for transport by a user.

FIG. 5 is a perspective view of a ladder formed by the interconnection of the base unit shown in FIG. 2 with a different ladder module.

FIG. 5A is a side view of the ladder shown in FIG. 5.

FIG. 6 is a perspective view of a ladder formed by the interconnection of the base unit shown in FIG. 2 with another different ladder module.

FIG. 6A is a side view of the ladder shown in FIG. 6.

FIG. 7 is perspective view of a walk-through ladder formed by the interconnection of the base unit shown in FIG. 2 with a walk-through ladder module.

FIG. 7A is a side view of the ladder shown in FIG. 7

FIG. 8 is a perspective view of a ladder having a longer ladder module.

FIG. 8A is a side view of the ladder shown in FIG. 8.

FIG. 9 is a perspective view of a ladder formed having a longer walk-through ladder module.

FIG. 9A is a side view of the ladder shown in FIG. 9.

FIG. 10 is a side view of a ladder system in which the base unit has legs according to an alternative implementation.

FIG. 10A is a side view of a ladder system in which the base unit has legs according to another alternative implementation.

FIG. 11 is a perspective view of a base unit according to an alternative implementation.

FIG. 12 is a perspective view of another alternative implementation of a ladder system.

FIG. 12A is a side view of the ladder system shown in FIG. 12.

FIG. 12B is an exploded perspective view of the ladder system of FIG. 12 shown from one direction.

FIG. 12C is an exploded perspective view of the ladder system shown from the opposite direction.

### DETAILED DESCRIPTION

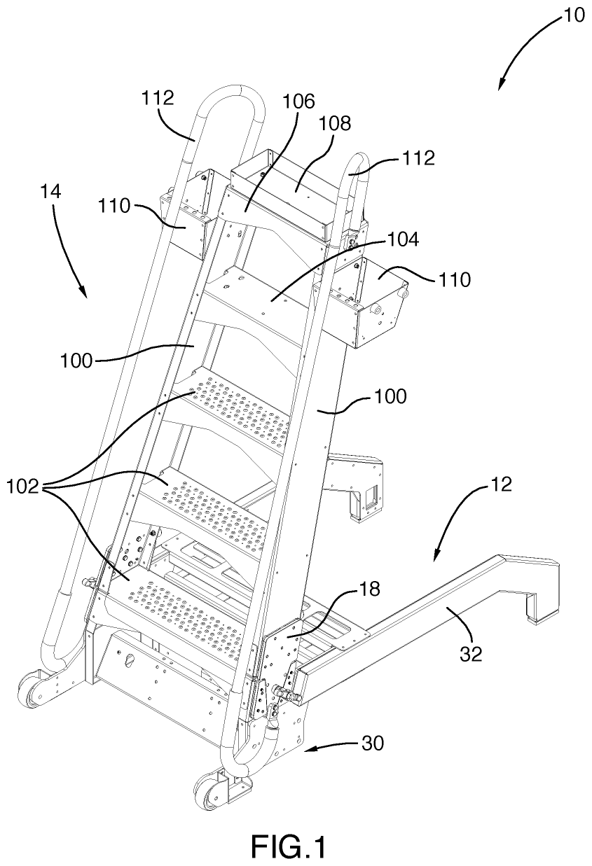

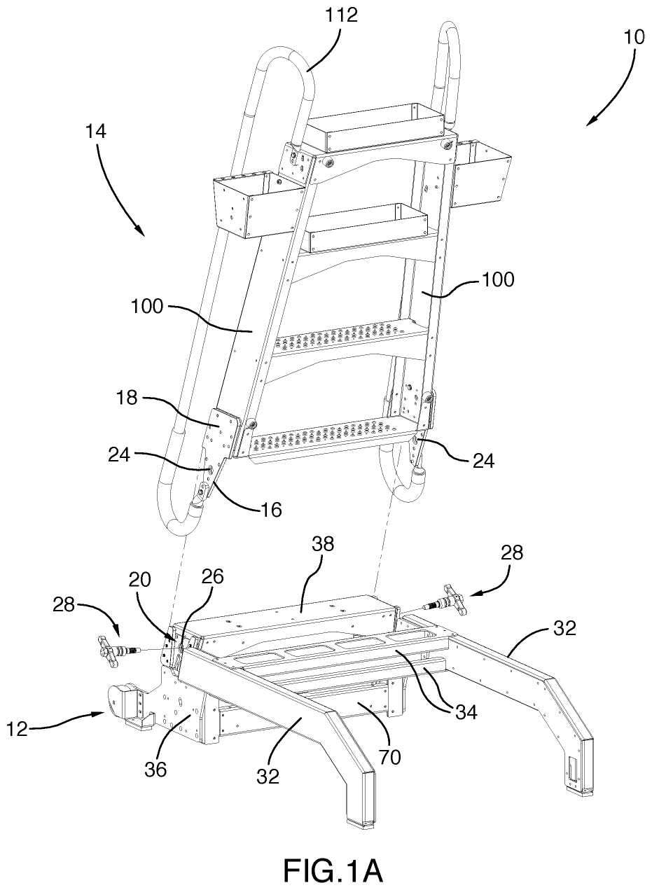

Referring to FIGS. 1 and 1A, a ladder system 10 includes a base unit 12 and a ladder module 14. The ladder module 14 is securely mounted to the base unit 12 and is cantilevered out from the base unit, providing clearance below the ladder that is not available with A-frame step ladders. The legs 32 of the base unit 12 provide excellent stability to the ladder system 10, allowing the ladder to be self-supporting and free-standing without the need for the rear rails and spreaders of a step ladder. This configuration is particularly advantageous in the field of aviation maintenance, as it allows the ladder system to be safely positioned adjacent the curved surface of a helicopter or airplane.

As can be seen in FIG. 1A, and as will be discussed in further detail below, the ladder module 14 can be disconnected from the base unit 12 and interchanged with a wide variety of other ladder modules. This advantageously allows a single, stable base unit to be used to support a wide variety of ladder modules. Because the ladder modules do not need to be (and are not) self-supporting, they can be lightweight and very easy to carry and maneuver. The base unit is compact and easy to transport and store, and its design can be readily customized to a particular application.

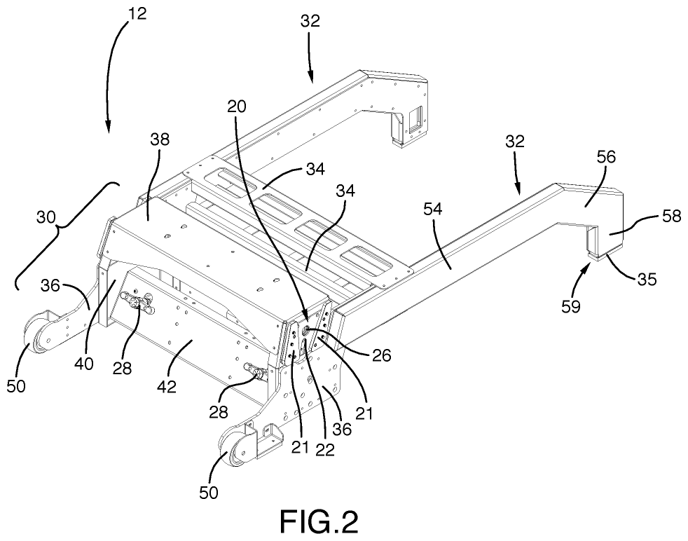

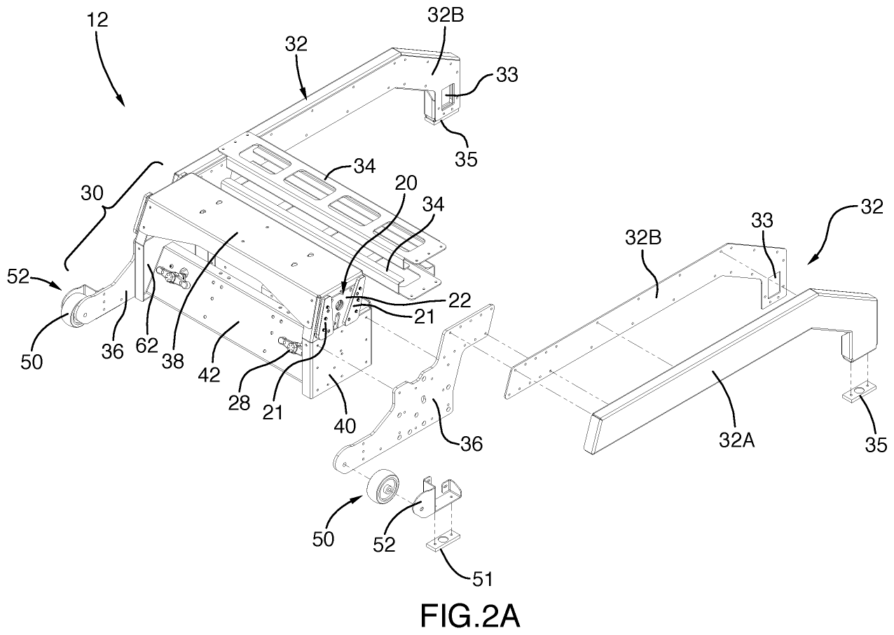

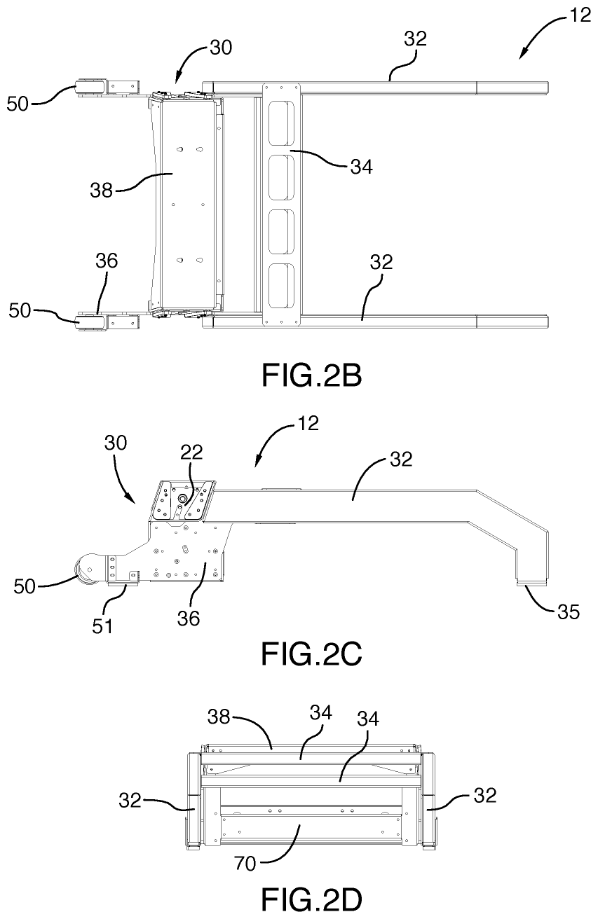

Referring now to FIGS. 2 and 2A, the base unit 12 includes a base assembly 30, a pair of support legs 32 extending horizontally from the base assembly 30, and a pair of upper and lower laterally extending beams 34 that connect the support legs and impart lateral stability and racking strength to the legs 32. The beams 34 are positioned relatively far from the distal ends of the legs 32, providing an open channel between the legs to accommodate the cross tubes of a helicopter, or in other applications parts of equipment to be serviced that would interfere with use of an A-frame type ladder.

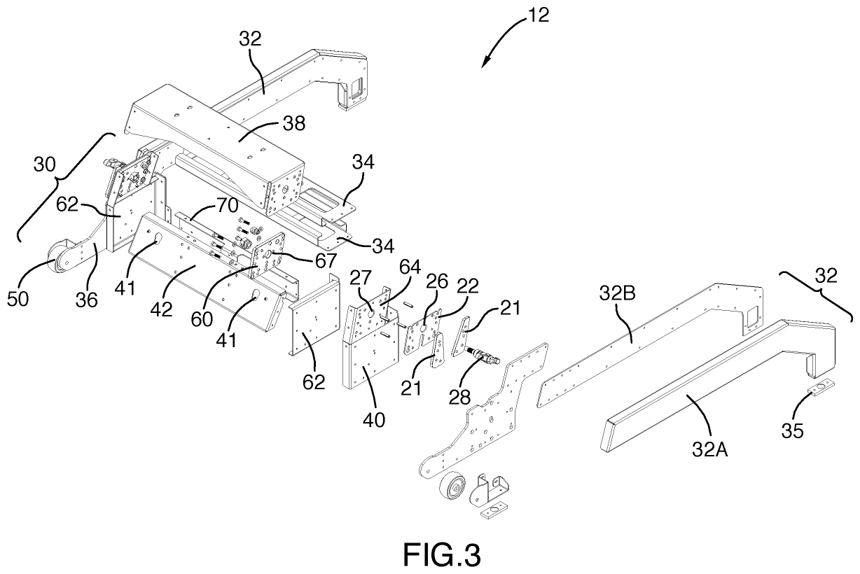

Each leg 32 is connected to the base assembly 30 by a plate 36, best seen in FIG. 2A. In the implementation shown in FIGS. 2A and 3 each leg is formed of an outer member 32A and an inner member 32B to facilitate manufacturing. Inner member 32B includes an access opening 33 to assist with installation and removal of an anti-slip foot 35. Referring to FIG. 2, the legs 32 have an arched shape, including a horizontal portion 54 that is spaced from the surface on which the base unit rests, an angled portion 56, and a vertical portion 58 that terminates in a distal end 59 which contacts and bears upon the surface on which the base unit rests. This arched shape provides clearance under the legs, for example for helicopter skid tubes of landing gear. The inclusion of the angled portion eliminates a 90 degree bend in the leg that could potentially damage an aircraft if the leg were to accidentally impact the airframe of the aircraft.

The length of the legs 32 is selected to provide sufficient stability to the ladder system 10. In some implementations the length is selected to provide stability to meet or exceed the tipping criteria of ANSI 14.2 Portable Metal Ladder Standard. The length is also generally selected to provide sufficient stability for the longest ladder module that is expected to be used with the base unit, as the minimum leg length required to meet stability requirements will be proportional to the length of the ladder module used with the base unit. In many cases, the length of the legs will be at least 1 meter.

Stability will also be impacted by the width of the base unit and the width between the side rails 100 of the ladder module, which can be adjusted if desired using bolt-on extensions as is well known in the ladder art.

As can be seen in FIGS. 2-2A, the base assembly 30 includes, as external components, a cover plate 38 and a pair of side walls 40 to which the cover plate 38 is attached. The cover plate 38 is not designed to function as a step and is not load bearing with respect to the ladder module. The cover plate 38 instead serves as a cover for the base assembly 30 and a bridge between the side walls 40. The base assembly 30 also includes a front plate 42 that extends laterally between the side walls 40 below the cover plate 38 forming a box structure with the side walls. Front plate 42 imparts strength to the base assembly 30 and includes apertures 41 (FIG. 3) configured to receive handwheels 28 for storage when not in use.

Referring to FIG. 3, the base assembly 30 further includes reinforcing plates 62 positioned inboard of the side walls. In combination with the side walls these reinforcing plates provide strength to the structure and safe load bearing for the ladder module and a user climbing the ladder module. The downward load of the ladder module and user is transmitted to the side walls via the connector arrangement that will be discussed below and distributed from the side walls to the reinforcing plates. Strength is also provided by the box structure formed by the side walls/reinforcing plates being connected to the laterally extending front plate 42 and a rear cross-piece 70.

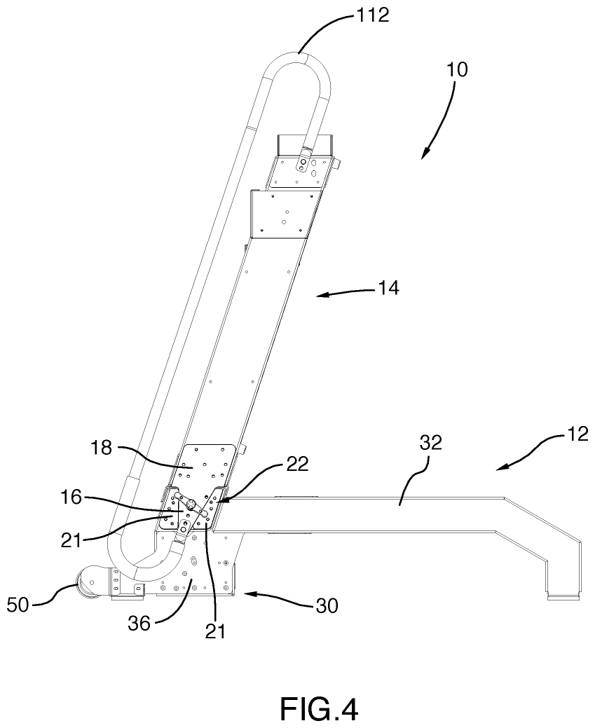

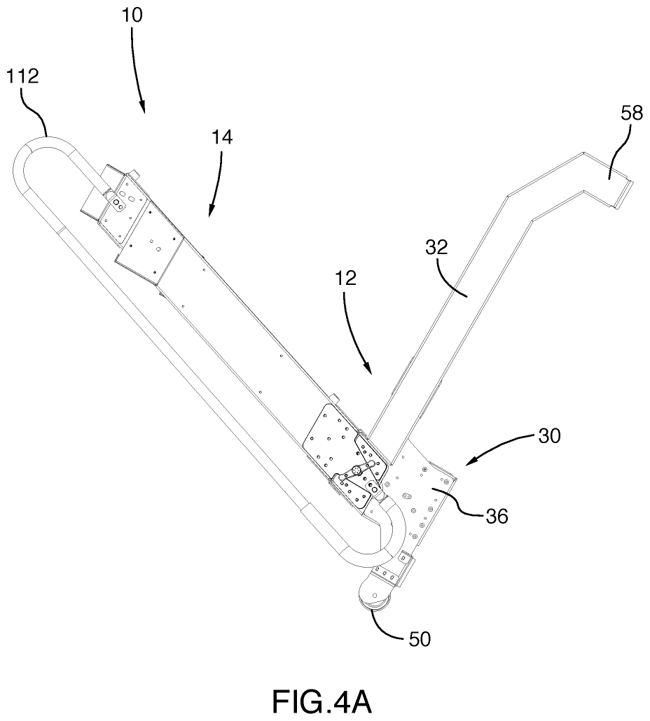

The base unit 12 also includes wheels 50, mounted securely at the front edge of the plates 36 by a bracket 52, as shown in FIG. 2A. These wheels allow the base unit 12 (or the base unit 12 and an attached ladder module) to be tipped up as shown in FIG. 4A and easily wheeled by a user to a desired location. Hand rails 112 may assist in tipping and wheeling of the base unit by functioning as handles that can be grasped by the user. Anti-slip feet 51 are provided on the brackets 52.

As shown in FIGS. 1 and 4, the base assembly 30 is configured to fit under the lowest step of the ladder module 14 and within the side rails 100 of the ladder module. Thus, the assembly 30 is configured so that the height of its uppermost surface (in the embodiment shown, the top surface of cover plate 38) above the surface on which the base unit is positioned, will be less than the height of a first step of a ladder permitted by ANSI or other applicable standards. In some implementations the base unit is configured so that the uppermost surface of the base assembly is from about 10 to 14 inches above the surface on which the base unit will be placed. The width of the base assembly 30 is selected to allow engagement of the connector arrangement discussed below, and to allow the side walls of the base assembly to align with the side rails 100. In some implementations (not shown) the legs 32 of the base unit 12 may be flared out to extend beyond the side rails 100 widthwise for added stability.

As shown in FIGS. 1A and 4, the ladder module 14 may be connected in a secure manner to the base unit 12 using a connector arrangement that includes, on each side of the ladder system, a tang element 16 extending downwardly from a module connector plate 18 secured to a rail 100 of the ladder module 14 and a complementary generally V-shaped receiving slot 20 (FIG. 1A) in a base connector plate 22 secured to a support plate 64 (FIG. 3) on the base assembly. The tang element 16, base connector plate 22, and support plate 64 include apertures 24, 26 and 27 which align when the tang element is received into the slot. A threaded handwheel 28 is inserted through the aligned apertures on each side and threaded into a threaded aperture 67 (e.g., a threaded nut, not shown) on a nut plate 60 (FIG. 3) to secure the ladder module 14 in place on the base unit 12. As can be seen in FIGS. 2A and 3, the receiving slot 20 is formed by a pair of opposed angled guide plates 21 that are secured to the base connector plate 22. The angled surfaces of the guide plates 21 assist with alignment of the tang element with the receiving slot 20. The receiving slot 20 receives the tang element 16 in a secure, stable engagement due to the wedge mechanics involved. The threaded handwheel may be configured (e.g., tapered) to preferentially contact a lower side of countersunk aperture 24 (FIG. 1A) due to an offset in centerline between the nut plate 60 and the tapered tang element. The resulting downward force on the lower side of the aperture 24 helps to wedge the tang element into the receiving slot 20.

The ladder module 14 shown in FIGS. 1-1A includes a pair of side rails 100, functional steps 102 mounted between the side rails, a platform 104 that is not designed to function as a step, and a top plate 106. The ladder module also includes a tray 108, tool holders 110, and handrails 112.

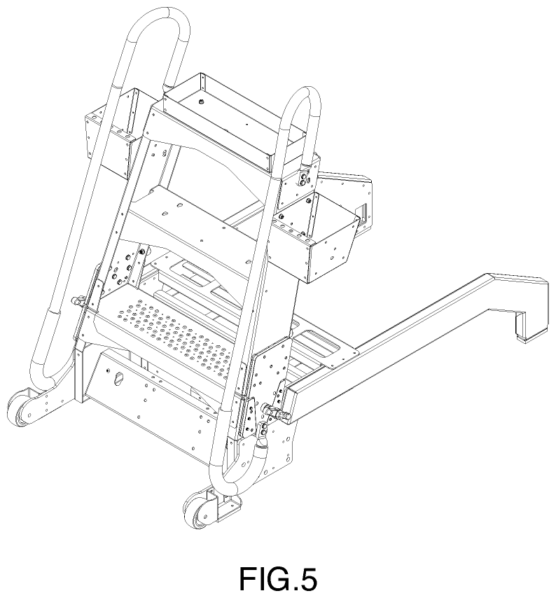

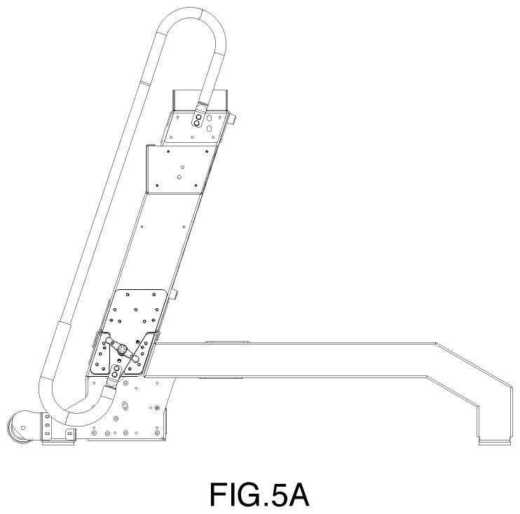

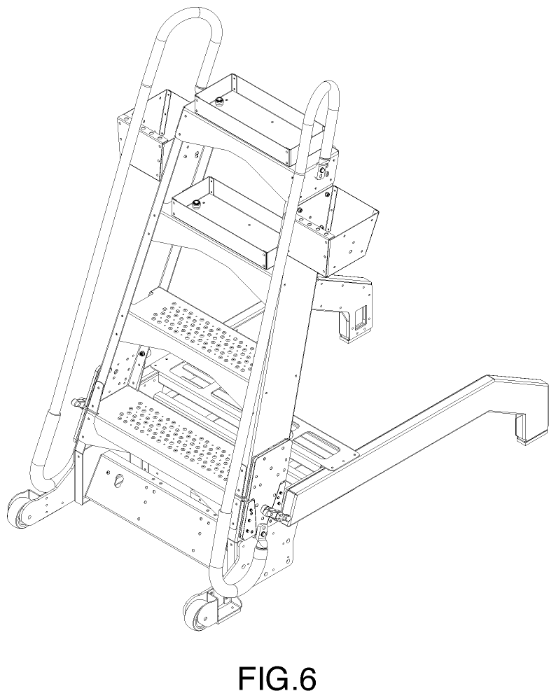

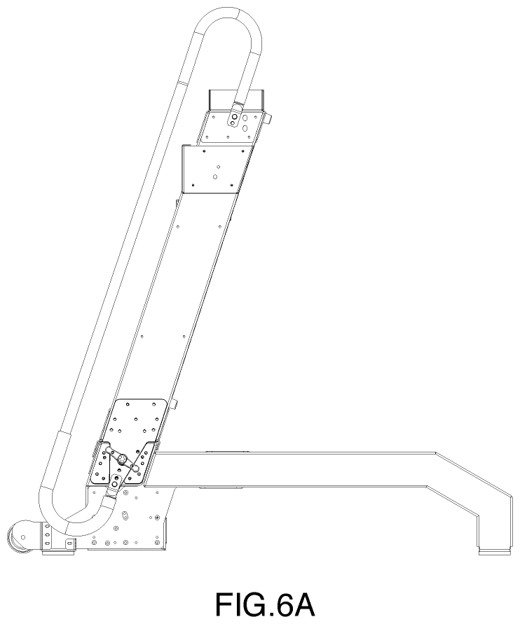

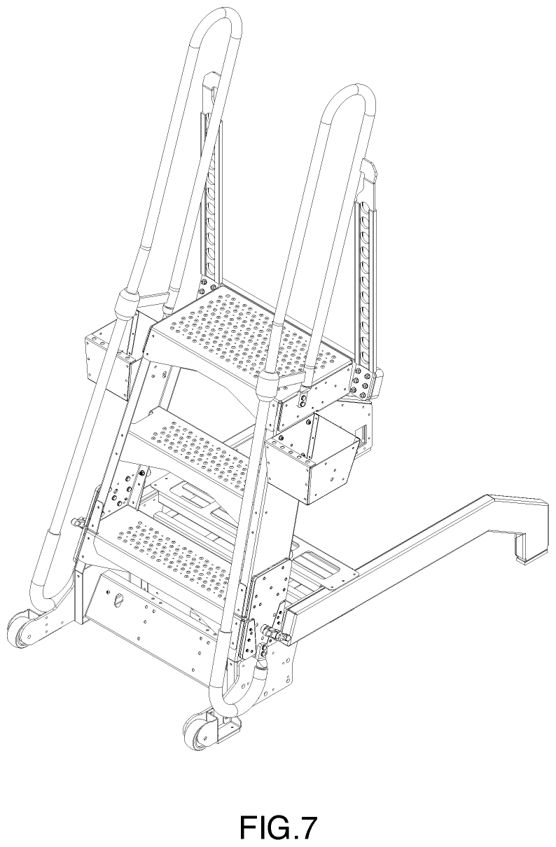

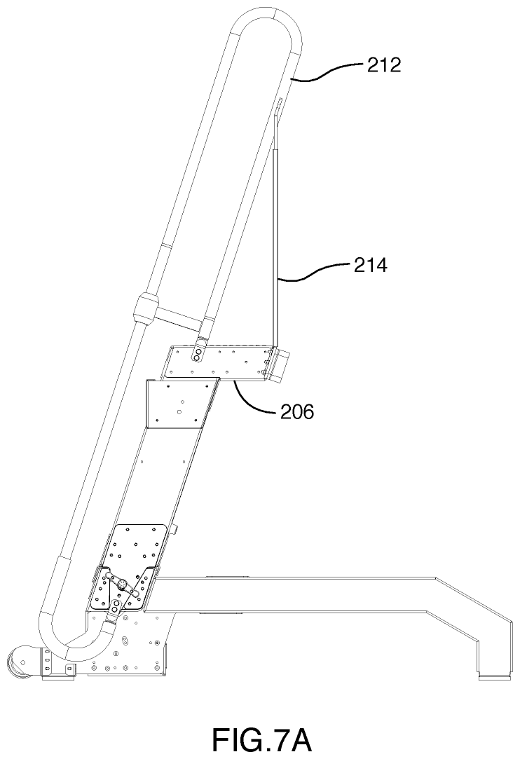

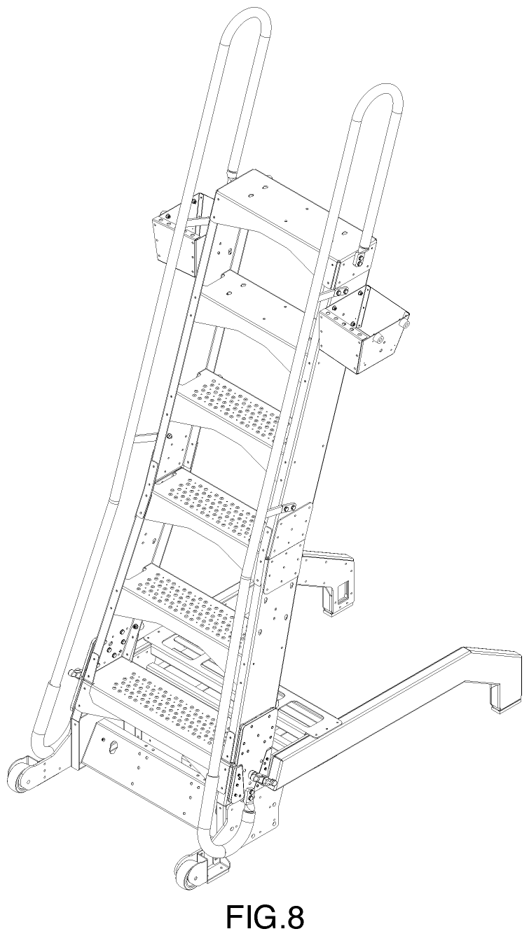

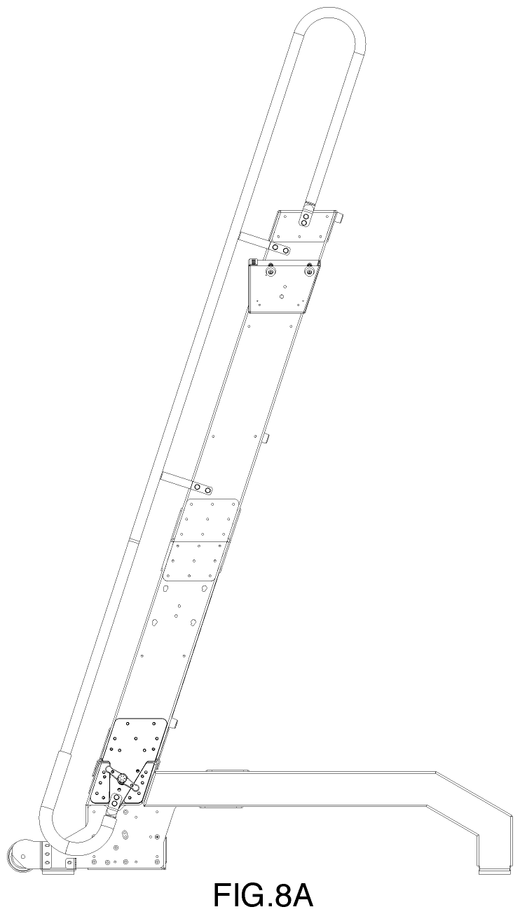

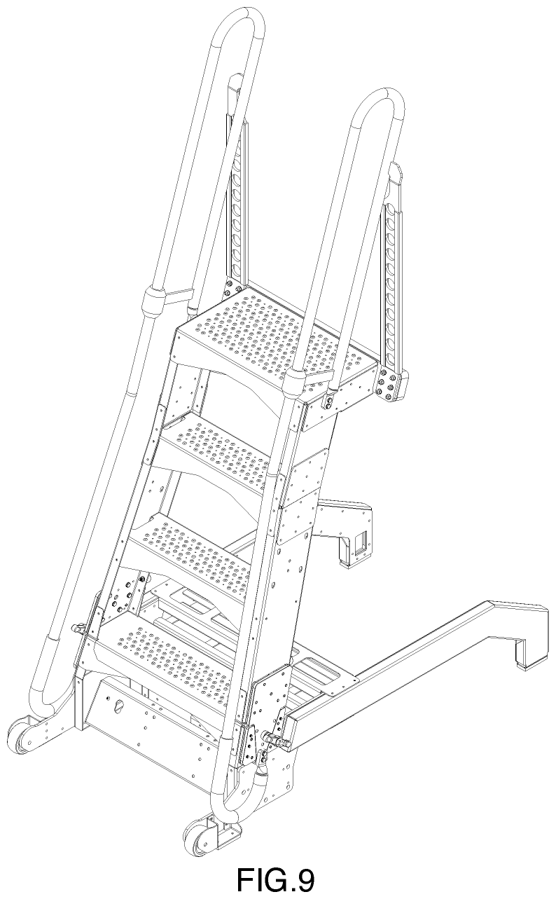

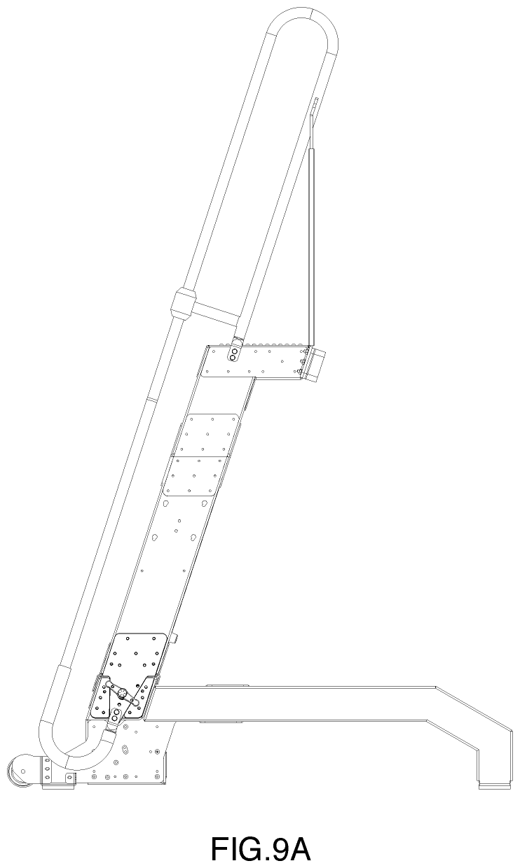

Many different types of ladder modules may be used interchangeably with the base unit 12 to form a wide variety of free standing ladders. Examples of ladders that can be formed using a single base unit include the ladders shown in FIGS. 5-9A, which include one and two step ladders (FIGS. 5-6A), four step ladders (FIGS. 8 and 8A), and three and four step walk through ladders (FIGS. 7-7A and 9-9A). Referring to FIGS. 7 and 7A, ladder modules used to form the walk through ladders typically include handrails 212 that extend further than normal above the top step 206 (which is a functional step in this case), thus requiring structural supports 214 to comply with ANSI standards for handrails.

The base unit and ladder modules may be fabricated from any desired rigid material, for example aluminum, steel, or composite materials. The components described herein may be fastened together in any suitable manner, including bolts, screws, rivets, welds, adhesives, and combinations thereof, as would be understood by those of skill in the art.

### Other Embodiments

A number of embodiments have been described. Nevertheless, it will be understood that various modifications may be made without departing from the spirit and scope of the disclosure.

For example, instead of the connector arrangement discussed herein, other types of connectors can be used, including those disclosed in U.S. Pat. No. 10,246,939 and other types of complementary engaging features or fastener systems. In some implementations the male element of the connector may be positioned on the base assembly and the female element positioned on the ladder modules.

Moreover, the legs may be configured differently to adapt the base unit for use in a particular application. The legs may, for example, be longer, e.g., for enhanced stability of longer ladder modules, or shorter, e.g., to accommodate space constraints. The legs may also be positioned further outboard of the base assembly, for additional side-to-side stability, or inboard, to accommodate space constraints. The legs may be configured to fold or telescope to allow for adjustment of length and/or ease of storage.

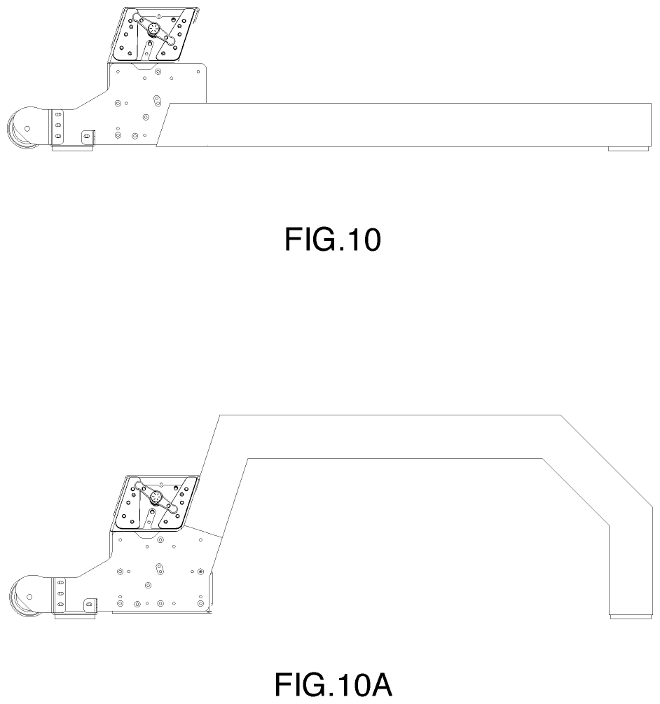

In addition, the profile of the legs may be altered to suit a particular application. For example, the legs may be configured to be positioned adjacent the surface on which the base unit is disposed, for example as shown in FIG. 10, or may have a lower arch than shown in the drawings and discussed above, to allow the legs to be positioned under objects. Alternatively, the legs may be more dramatically arched, as shown in FIG. 10A, to provide higher clearance for objects on the ground.

In some cases, the legs may be removable from the base assembly, e.g., to allow different leg configurations to be interchanged to adapt the base unit to different use constraints.

In some implementations the angled portion of the leg may be omitted, i.e., the horizontal and vertical portions of the leg may meet at a right angle or may be replaced by a curved section.

The base assembly may be modified from the configuration described with reference to FIG. 3. For example, the side walls may be formed of a single, thicker plate, rather than the multiple assembled parts described above.

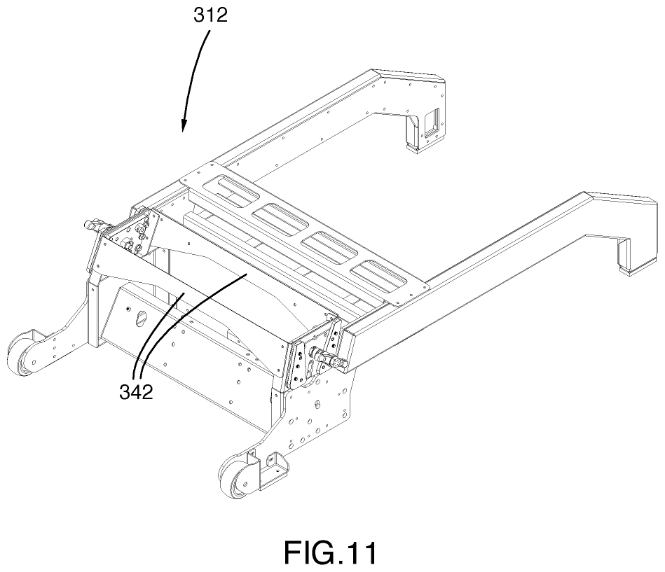

In the embodiment described above, the cover plate 38 is not load bearing for the ladder module, and thus it can be omitted, in which case the lateral stability provided by the cover plate may be provided in a different way. For example, as shown in FIG. 11, a base unit 312 according to an alternative implementation includes, instead of cover plate 38, a pair of brace members 342.

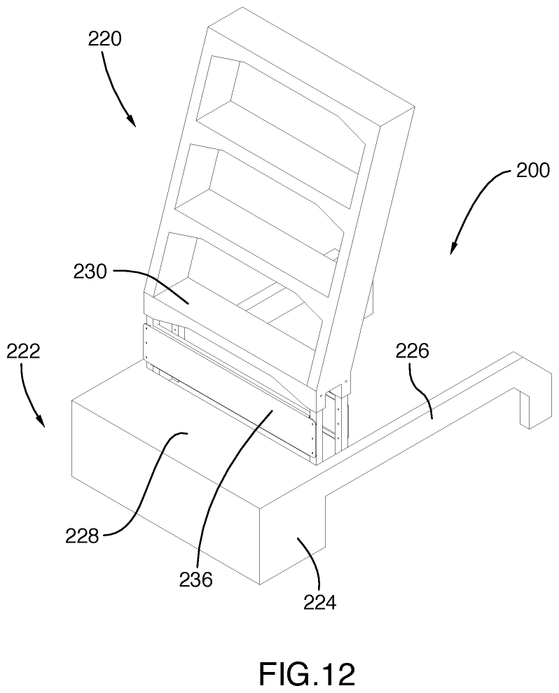

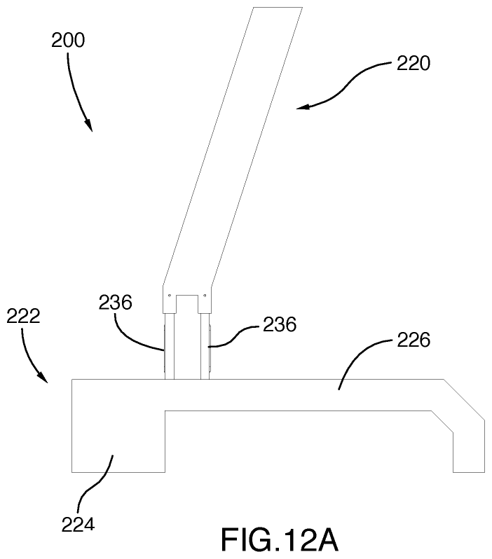

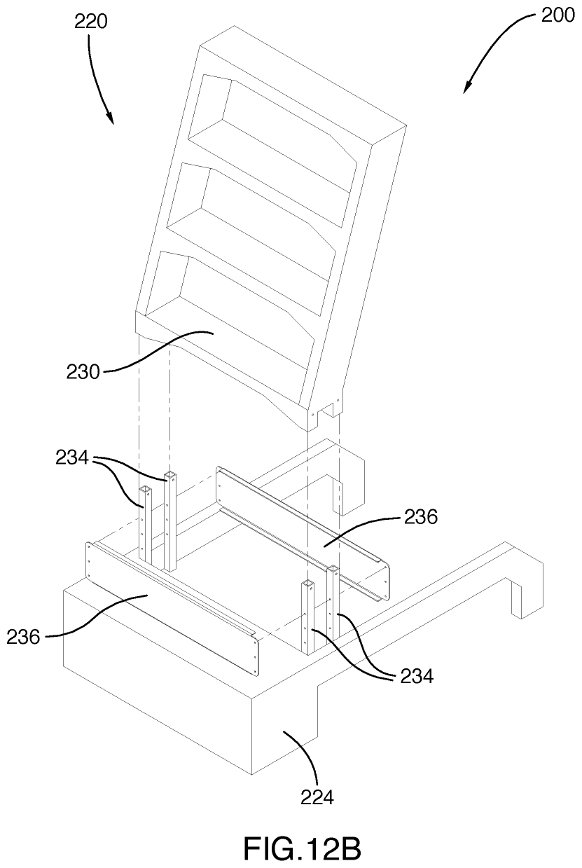

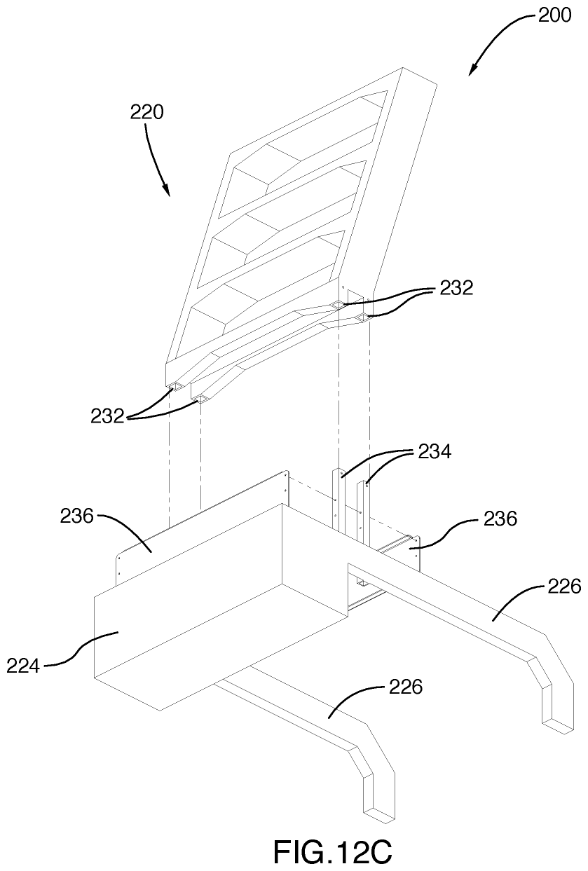

Alternatively, in some embodiments, the base assembly may be configured to be a load bearing step, and the ladder modules may be mounted behind the base assembly rather than the base assembly being positioned below the first step of the ladder module. An example of such an embodiment is shown in FIGS. 12-12C. In the system 200 shown in these drawings a ladder module 220 attaches to a base unit 222 having a base assembly 224 and support legs 226. The support legs 226 extend outboard of the ladder module 220, and the base assembly 224 extends forward of the ladder module. In this embodiment the upper surface 228 (FIG. 12) of the base assembly serves as a step, from which the user steps upward onto a first ladder step 230 of the ladder module 220. The ladder module 220 includes four receiver openings 232 (FIG. 12C) configured to receive a corresponding four posts 234 (FIG. 12B) that are attached to the inward facing surfaces of the support legs 226. Cross bracing panels 236 tie the posts 234 together and form a box structure to provide strength. The front cross bracing panel also serves as a toe kick plate for the ladder module 220. A ball detent pin or the like (not shown) may be provided to secure the posts 234 within the openings 232.

Accordingly, other embodiments are within the scope of the following claims.

What is claimed is:

1. A ladder system comprising:
a base unit comprising a base assembly and a pair of support legs extending horizontally from the base assembly; and
at least one ladder module configured to be releasably mounted on the base unit to extend vertically therefrom;
wherein the base unit and ladder module together form a stable free-standing ladder in which the ladder module is cantilevered out from the base unit.

2. The ladder system of claim 1, wherein the support legs extend to distal ends configured for engagement with a surface on which the base unit is positioned.

3. The ladder system of claim 2, wherein the support legs have an arched profile.

4. The ladder system of claim 1, wherein the base assembly comprises a box structure having side walls connected by lateral supports.

5. The ladder system of claim 4, wherein the base assembly is configured such that the side walls are load bearing for the ladder module.

6. The ladder system of claim 5, further comprising a base unit connector element mounted on each side wall and a corresponding ladder module connector element mounted on a side rail of the ladder module for engagement with the base unit connector element.

7. The ladder system of claim 6, wherein the base unit connector element comprises a generally V-shaped slot and the ladder module connector element comprises a tang element shaped to fit within the slot in a wedged engagement.

8. The ladder system of claim 1, comprising a set of ladder modules having different configurations for interchangeable use with the base unit.

9. The ladder system of claim 1, wherein the ladder module is a walk-through ladder module.

10. The ladder system of claim 1, wherein the base assembly is configured to be positioned under a lowermost step of the ladder module.

11. A base unit for use in a ladder system that includes a plurality of ladder modules, the base unit comprising:
a base unit comprising (a) a base assembly having a pair of connector elements configured to engage a corresponding pair of connector elements on a ladder module in a releasable locking and load bearing engagement, and (b) a pair of support legs extending horizontally from the base assembly, at least a portion of each support leg being in contact with a surface on which the base unit is positioned during use.

12. The base unit of claim 11, wherein the base unit is configured to support the ladder module so as to form a stable free-standing ladder in which the ladder module is cantilevered out from the base assembly.

13. The base unit of claim 11, wherein the base assembly is configured to be positioned under a lowermost step of the ladder module.

14. The base unit of claim 11, wherein the support legs have an arched profile.

15. The base unit of claim 11, wherein the base assembly comprises a box structure having side walls connected by lateral supports.

16. The base unit of claim 15, wherein the base unit is configured such that the side walls are load bearing for the ladder module.

17. A method comprising:
providing (a) a plurality of ladder modules, each of the ladder modules including a pair of connecting elements, and (b) a base unit comprising (i) a base assembly; (ii) a pair of connector elements configured to engage the connector elements on the ladder modules in a releasable locking and load bearing engagement, and (iii) a pair of support legs extending horizontally from the base assembly,
positioning the base unit on a surface such that at least a portion of each support leg is in contact with the surface; and
attaching a first one of the ladder modules to the base unit by engaging the connector elements on the first ladder module with those of the base unit to form a free-standing ladder.

18. The method of claim 17, further comprising detaching the first ladder module from the base unit by disengaging the connector elements of the first ladder module from those of the base unit.

19. The method of claim 18, further comprising attaching a second one of the ladder modules to the base assembly by engaging the connector elements on the first ladder module with those on the base unit.

20. The method of claim 17, wherein the base assembly includes wheels, and the method further comprises using the wheels to move the base unit, with or without the first ladder module attached, from a first location to a second location.

21. The method of claim 17, further comprising positioning the free-standing ladder adjacent to a piece of equipment having a curved surface such that a distal end of the first ladder module is cantilevered out from the base unit and is positioned to allow a user to service the piece of equipment from the ladder.
